(19) United States
(12) Patent Application Publication
(10) Pub. No.: US 2006/0012676 A1
(43) Pub. Date: Jan. 19, 2006

(54) Stereoscopic image display

(76) Inventor: Seijiro Tomita, Komae-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 11/180,687

(22) Filed: Jul. 14, 2005

(30) Foreign Application Priority Data
Jul. 15, 2004 (JP) 2004-208732

(51) Int. Cl. H04N 13/04; H04N 15/00

(52) U.S. Cl. 348/51

(57) ABSTRACT

The present invention discloses a stereoscopic image display which can display all the information of an image for the right eye and an image for the left eye without using a time division method. Such stereoscopic display has not been realized by the conventional art without glasses. When an image signal for the right eye and an image signal for the left eye are divided into a stereoscopic image synthesis signal for an odd-numbered line and a stereoscopic image synthesis signal for an even-numbered line for displaying an image, either line is regarded as an image signal for the either eye and other line as an image signal for the other eye. Then, the display is set vice versa: the above first line is set as an image signal for the other eye and the above other line as an image signal of the above first eye. Thus, the order is arranged so as to display an image display signal and a frame signal for erasing screen in an alternate arrangement.

### BACKGROUND OF THE INVENTION

1. Field of the Invention

The present invention relates to a stereoscopic image display which displays an image signal for the right eye and an image signal for the left eye of a stereoscopic image as a stereoscopic image signal without using. a time division display method.

2. Description of the Prior Art

A stereoscopic image display which is disclosed in Japanese Patent Disclosure No. 10-63199 has been known as an apparatus which displays a stereoscopic image to an observer without conventional glasses, the apparatus laterally displaying a right-eye image and a left eye image on a screen by placing them side by side on each horizontal line, as shown in FIG. 5.

The stereoscopic image display described in the above patent disclosure divides all the horizontal scanning lines on a display screen into odd lines and even lines, and then displays an image for the right eye and an image for the left eye on each line to produce a stereoscopic image with the displayed images sorted into an image for the right eye and an image for the left eye of an observer by an optical means. The display method has solved problems, including: a halving of a horizontal resolution that is an impairment of a conventional lenticular system and parallax barrier system; and a phenomenon that a left image and a right image is inverted according to the change of a viewing position. But the method still has a problem such that since a display position of an image signal for the right eye and a display position of an image signal for the left eye of a display screen are always fixed, a vertical resolution of the right image and the left image are reduced to half.

In order to solve the problem, the inventor had proposed a solution (PCT/JP2004/001694) which has solved a problem that the vertical resolution is reduced to half by a means, the means being that a combination of an image for the right eye with an image for the left eye to be presented on an even line and an odd line per frame is inverted and a light source is simultaneously controlled. But the previous invention could not have solved a problem in a cross talk of a left image and a right image in a case in which a conventional liquid crystal display element is used.

Further, a stereoscopic image visualization apparatus which is disclosed in Japanese Patent Disclosure No. 9-51552 has been known as a conventional means requiring no glasses, which repeats an image screen for the right eye, an entire-screen black and an image screen for the left eye in a time division manner, as shown in FIG. 6.

But, with the above patented device, since a right image and a left image alternately reaches to both the right eye and the left eye of an observer at different times, many flickers are produced, and thus a natural image which observers usually see cannot be obtained. As a method to reduce these flickers, there are methods which apply liquid crystal display element that is switchable at a high speed, but the methods are very expensive and give an insufficient light volume which still remains a big problem to be solved.

By the way, there is a method which does not apply a visualization method in a time division manner as shown in the above patent, dividing an image into an image for the right eye and an image for the left eye of an observer with a polarizing filter and an optical means to display a stereoscopic image. In order to display all the image information with the method, all the horizontal scanning lines on a frame-display screen are divided into an odd line and an even line to display an image for the right eye and an image for the left eye on each line, and then a position for displaying a stereoscopic image for the right eye and a position for displaying a stereoscopic image for the left eye are counterchanged per frame accompanied with a simultaneous counterchanging of a light source for the right eye and a light source for the left eye. But, in a case in which a conventional liquid crystal display element is applied to the image display element, since an updated information of a frame image sequentially writes over the screen from the upper horizontal line to the bottom horizontal line as shown in FIG. 7, the eyes of an observer always sees the previous screen and a next new screen at the same time. With the method there is a problem such that it is difficult to recognize a stereoscopic image due to many cross talks even if the light source is replaced.

The present invention has been made to solve the above problems with the following purposes. The purposes are to provide a stereoscopic image display which stereoscopically displays entire image information for the right eye and the left eye that could not have been realized with conventional stereoscopic image display methods and a novel stereoscopic image display which blocks an afterimage for the right eye and the left eye and a cross talk (leakage of the right image and the left image).

### SUMMARY OF THE INVENTION

In view of the above problems in the conventional art the present invention has as an object to provide a stereoscopic image display with the following aspects.

A first aspect of the present invention provides a stereoscopic image display which simultaneously displays a right stereoscopic image and a left stereoscopic image on a frame screen and divides an image into an image for the right eye and an image for the left eye of an observer with a polarizing filter and an optical means to display a stereoscopic image, wherein:

an image signal for the right eye and an image signal for the left eye are arranged on an odd horizontal line and an even horizontal line of a frame image, respectively; and

a frame image in which the horizontal line for the image signal for the right eye and the horizontal line for the image signal for the left eye are alternately arranged per frame and a frame image for erasing screen are repeatedly displayed.

For example, a frame image is repeatedly displayed in a following order: an image signal for the right eye and an image signal for the left eye are displayed on an odd horizontal line and an even horizontal line, respectively; then a frame image for erasing screen is displayed; next, an image signal for the right eye and an image signal for the left eye are displayed on an even horizontal line and an odd horizontal line respectively; and then, a frame image for erasing screen is displayed.

A second aspect of the invention provides a stereoscopic image display based on a technical base of the stereoscopic image display according to claim 1, in which the frame image and the frame image for erasing screen are repeated at on or more than twice a conventional speed. The stereoscopic image display may solve a delay.

A third aspect of the invention provides a stereoscopic image display based on a technical base of the stereoscopic image display according to either claim 1 or claim 2, in which details of a frame image for erasing screen is controlled according to details of a right image signal, a left image signal, an anterior frame image, and a posterior frame image. The stereoscopic image display may solve a flicker and an insufficient light volume.

A fourth aspect of the invention provides a stereoscopic image display based on a technical base of the stereoscopic image display according to either claim 1 or claim 2, in which a brightness of a light source at a timing of displaying a frame image for erasing screen is controlled according to details of a right image signal, a left image signal, an anterior frame image, and a posterior frame image. The stereoscopic image display may solve a flicker and an insufficient light volume.

A fifth aspect of the invention provides a stereoscopic image display based on a technical base of the stereoscopic image display according to either claim 1 or claim 2, in which a display of a frame image for erasing screen is performed during a blanking period of an image signal. The stereoscopic image display may solve a flicker and an insufficient light volume.

### BRIEF DESCRIPTION OF THE DRAWINGS

FIG. 1 is a system of a stereoscopic image display for an example of the invention.

FIG. 2 illustrates a synthetic example of a stereoscopic image signal of the above stereoscopic image display system.

FIG. 3 illustrates a relation between a switch-over at a timing 1 and a timing 2 of the above stereoscopic image display and a display timing of a stereoscopic image synthesis signal.

FIG. 4 illustrates an exploded, squinted view of a structure of the above stereoscopic image display.

FIG. 5A shows an optical plain view of a conventional stereoscopic image display and FIG. 5B shows an exploded, squinted view of a liquid crystal display element.

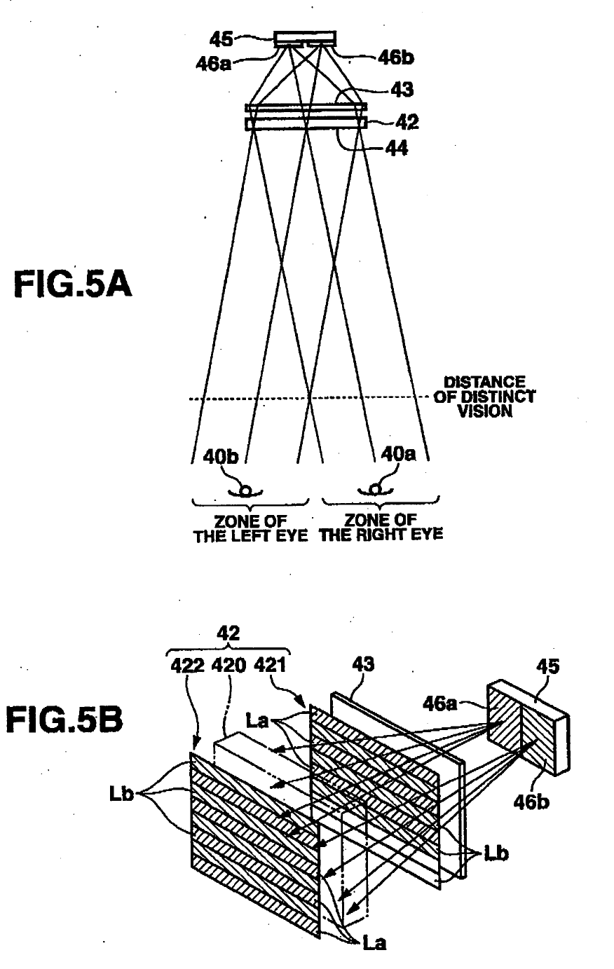

FIG. 6 illustrates a structure of a conventional stereoscopic image display.

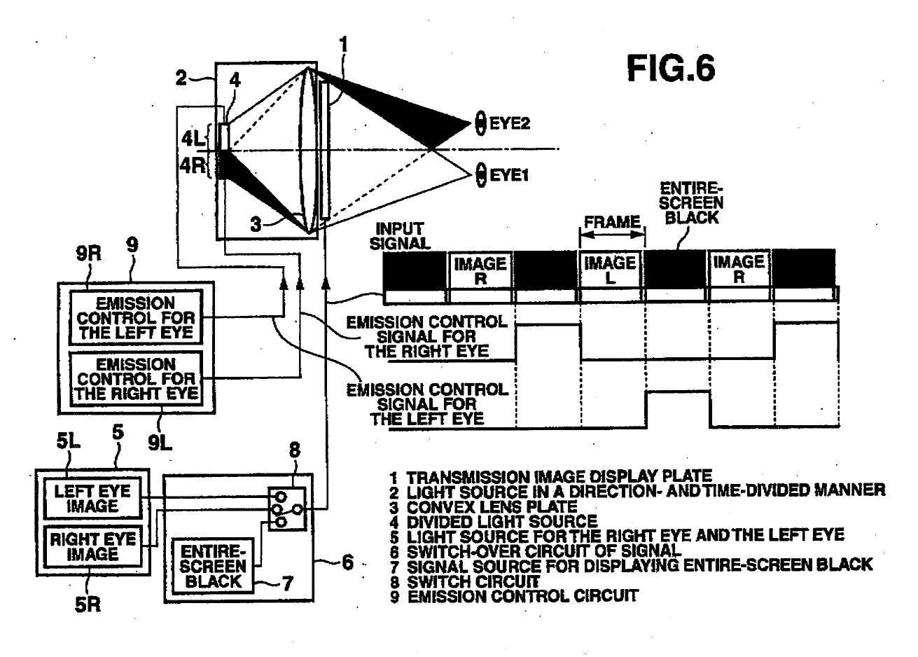

FIG. 7 illustrates a display method of a general liquid crystal display.

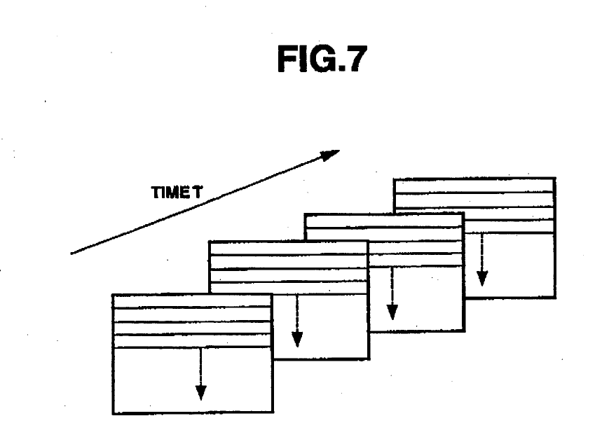

### DETAILED DESCRIPTION OF THE PREFERRED EMBODIMENT

A preferred embodiment of the present invention will now be described with reference to the figures. However, as the embodiment is a preferred one, various limitations are included therein which are preferable in view of technical reasons. However, a scope of the present invention is not limited the embodiment 1 unless any limitation of the present invention is particularly specified in the description below

### FIRST EMBODIMENT

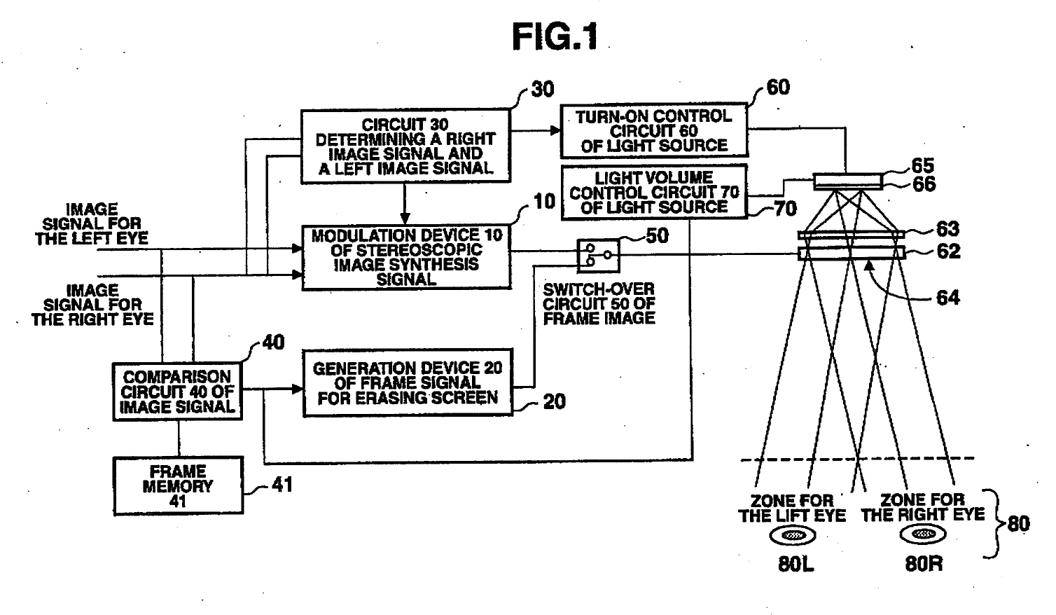

A stereoscopic image display comprises, as shown in FIG. 1: a modulation device 10 of stereoscopic image synthesis signal which converts an image for the right eye and an image for the left eye of a stereoscopic image to a non-interlaced stereoscopic image signal; a generation device 20 of frame signal for erasing screen; a switch-over circuit 50 of frame image; a comparison circuit 40 of image signal; a circuit 30 determining a right image signal and a left image signal; a turn-on control circuit 60 of light source which is controlled by the circuit 30; and a light volume control circuit 70 of light source.

A frame memory 41 is used for temporarily storing an image signal so as to compare a right image signal to a left image signal and an anterior frame image to a posterior frame image.

In the embodiment 1, a camera in an interlaced manner is used for an image signal for the right eye and an image signal for the left eye. A camera either in non-interlaced manner or in hi-vision manner can be used, and a still image digital camera may be used as well. Further, without using two types of signals, a stereoscopic image signal in which a right image and a left image are combined to a type may be applied. A computer graphic system in which a computer renders a right image and a left image can also be used.

The image signal for the right eye and the image signal for the left eye shown in FIG. 1 are controlled so that a relation on the axis of time is kept in an order either of an even number field to an odd number field or of an odd number field to an even number field, and then transmitted to the modulation device 10 of stereoscopic image synthesis signal.

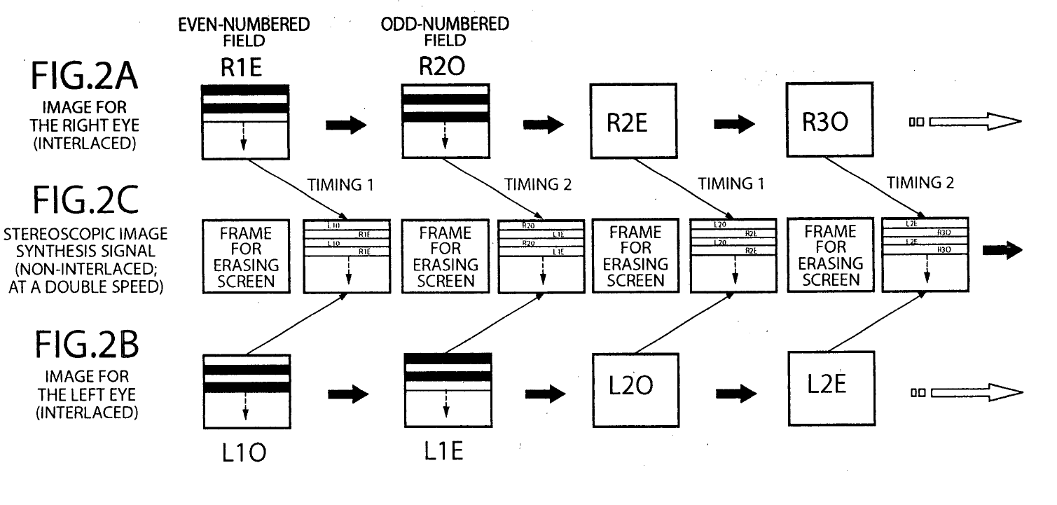

As shown in FIG. 2, the modulation device 10 of stereoscopic image synthesis signal divides the right image and the left image into an odd line and an even line, and then synthesizes to modulate into an image of a stereoscopic image synthesis signal in a non-interlaced manner (See FIG. 2C) for outputting in the switch-over circuit 50 of frame image. At this time, there are two alternatives comprising: an alternative in which an image signal for the left eye is used for an odd number field and an image signal for the right eye is used for an even number field; and another alternative in which an image signal for the right eye is used for an odd number and an image for the left eye is used for an even number. The alternative is determined with the circuit 30 determining a right image signal and a left image signal in which a specified signal and so forth installed in each image signal are used. Then, a line for an image signal for the right eye and a line for an image signal for the left eye are alternately arranged per frame, and a right image signal and a left image signal are controlled by each interlaced frame image.

The switch-over circuit 50 of frame image operates at a double speed and switches over an image signal from the generation device 20 of frame signal for erasing screen and a stereoscopic image synthesis signal modulated at the modulation device 10 of stereoscopic image synthesis signal one after the other to output in a liquid crystal display element 62. Accordingly, an observer can see a stereoscopic image.

Further, the comparison circuit 40 of image signal compares a difference between a right image signal and a left image signal as well as a difference between an anterior frame image and a posterior frame image using a frame memory circuit 41, and then outputs information for making an optimal frame image for erasing screen in the generation device 20 of frame signal for erasing screen. At the same time, the circuit 40 transmits the information to the light volume control circuit 70 of a light source which controls a light volume of the light source, for determining an optimal light volume.

The turn-on control circuit 60 of light source switches over a light source for the right eye and the left eye per frame based on information from the circuit 30 determining a right image signal and a left image signal.

The above is a signal flow of the invention. The below is a detailed explanation of the mechanism.

The modulation device 10 of stereoscopic image synthesis signal receives a series of image signals in an interlaced manner such as R1E, L10, R20, R1E, R2E, L20, L30 and L2E which are input from the right and left image signals at a speed of 1/60 per second, as shown in FIGS. 2A and 2B. Symbols in the description of the invention show the followings: L for an image for the left eye; R for an image for the right eye; a figure for a frame number; O for an odd field; and E for an even field.

The modulation device 10 of stereoscopic image synthesis signal modulates a received signal into a set of non-interlaced stereoscopic image synthesis signals consisting of a signal starting from L and a signal starting from R, like a stereoscopic image synthesis signal shown in FIG. 2C. Hereat, the generation device 20 of fame signal for erasing screen makes a frame signal for erasing screen based on the information from the comparison circuit 40 of image signal, and then outputs in the switch-over circuit 50 of frame image.

The switch-over circuit 50 of frame image switches over a non-interlaced stereoscopic image synthesis signal and a frame signal for erasing screen at a double speed to supply to the liquid crystal display element 62.

As shown in FIG. 2C, with such switch-over, a stereoscopic image synthesis signal which is input in the liquid crystal display element 62 is modulated into a series of non-interlaced signals at a double speed which are arranged in an order of a frame image for erasing screen—a stereoscopic image synthesis signal starting L—a frame image for erasing screen—a stereoscopic image synthesis signal starting R—a frame image for erasing screen.

Thus, since a frame image for erasing screen can erase a previous screen, a problem that a next new screen can be displayed at the same time may be solved thereby. An afterimage of a right image, an afterimage of a left image, and a cross talk can be eliminated. Of course, a stereoscopic image synthesis signal increases to a double speed as shown in FIG. 2C. Thus, an element which performs at a double speed is adopted as a liquid crystal display element 62.

The following explains a frame image for erasing screen.

The liquid crystal display element 62 generates a frame image for erasing screen which is based on the information of the comparison circuit 40 of image signal.

For example, if a simple signal for entire-screen black is used as a frame image for erasing screen, a black screen is inserted in between both frame images to create a flicker and an insufficient light volume.

In the embodiment 1, an optimal frame image is produced by comparing a right image signal and a left image signal with an anterior frame image and a posterior frame image. For example, a known low-pass filter can display a stereoscopic image with less flicker without reducing a light volume by a means in which an image consisting only of component with low frequency is first produced to extremely reduce an anteroposterior change and then an average of the brightness of an image signal is detected to control the brightness of a frame image for erasing screen.

At the same time, more effect can be obtained by a means in which an output of the comparison circuit 40 of image signal is transmitted to the light volume control circuit 70 of a light source to control an light volume of a light source.

Next, the followings illustrate details of a mechanism in which a stereoscopic image of the invention is displayed.

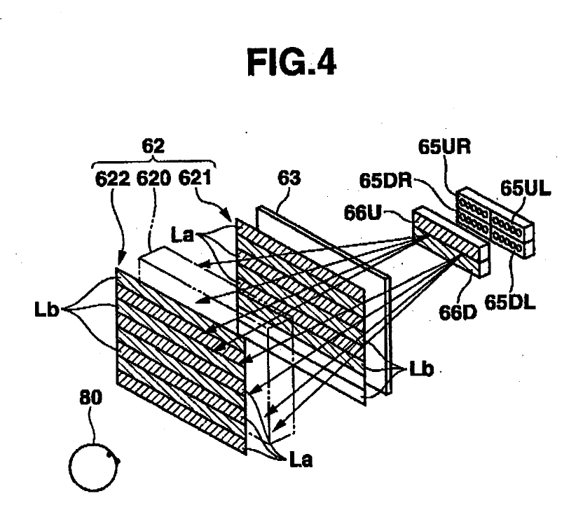

As shown in FIG. 4, the mark 62 shows a liquid crystal display element. On the backside of the liquid crystal display element 62, a Fresnel lens 63 is arranged at an interval of a given distance. The Fresnel lens 63 has an asperity surface which is concentric on a side surface, being placed so that an incident light from a focal point at the center of the backside of the Fresnel lens is emitted as a near-parallel light, and having a function for dividing the obtained image into an image for the right eye and an image for the left eye of an observer 80.

The front of the liquid crystal display element 62 is equipped with a diffuser 64 having a diffusion performance only in a vertical direction. A light transmitted from the liquid crystal display element 62 is emitted from the diffuser 64 to the direction of the observer. Thus, the diffuser 64 is used for expanding a visual field in the vertical direction.

Further, a mark 65 in FIG. 4 shows a backlight light source for irradiating the liquid crystal display element 62 from the backside. In the embodiment 1, as shown in FIG. 4, a backlight light source 65 is comprised of LEDs which are divided into 4 blocks that can control a turn-on separately.

With the backlight light source, a block 65 UR as a backlight light source and a block 65 DR as a backlight light source are light sources for a zone for the right eye of an observer; a block 65 UL as a backlight light source and a block 65 DL as a backlight light source are light sources for a zone for the left eye of an observer.

The front (the irradiation side) of the backlight light source 65 is equipped with a polarizing filter 66U for the right eye and a polarizing filter 66D for the left eye.

The polarizing filter 66U for the right eye and the polarizing filter 66D for the left eye are arranged as a linear polarizing filter which polarization direction intersects orthogonally with each other. For example, a plane of polarization upward from left to right and a plane of polarization upward from right to left are formed.

Further, the liquid crystal display element 62 is a light transmission type, and has two polarizing filters 621 and 622 which are arranged on the both sides of a liquid crystal panel 620 as shown in FIG. 4.

A liquid crystal panel 620 houses, for example, a liquid crystal which is twisted 90 degrees inward of a pair of oriented films. If a power voltage is not applied between a pair of oriented films, the panel 620 rotates an incident light 90 degrees to emit; if a power voltage is applied between a pair of oriented films, the panel 620 does not rotate an incident light and emits it as it is. Two polarizing filters 621 and 622 are arranged so that a line part La of a linear polarization filter and a line part Lb of a linear polarization filter which orthogonally intersect with each other are alternated per horizontal line of a liquid crystal panel, respectively; they are arranged so that a line part La of a linear polarization filter and a line part Lb of a linear polarization filter in which are placed against a light source (backside) and an observer (front side) orthogonally intersect in a polarizing direction.

Therefore, since a light either from a polarizing filter part 66U for the right eye or a polarizing filter part 66D for the left eye enters only from a line part La of a linear polarization filter and a line part Lb of a linear polarization filter of a same polarizing face, each light enters from every other horizontal line. If no voltage is imposed, each entered light is transmitted; if a voltage is imposed, each entered light is blocked.

Further, the liquid crystal panel 620 of the liquid crystal display element 62 is constructed so as to show that image information for the right eye and image information for the left eye are alternately displayed per horizontal line in parallel with a translucent line of two polarizing filters 621 and 622.

Therefore, if an observer sees the liquid crystal display element 62 from a distance of distinct vision, only an image for the right eye is transmitted to the right eye 80R and only an image for the left eye is transmitted to the left eye 80L, separately. Accordingly, the observer can see as a stereoscopic image thanks to a stereoscopic perception according to a binocular disparity.

In the example of the liquid crystal display element 62 shown in FIG. 4, two polarizing filters 621 and 622 are arranged on the both sides of the liquid crystal panel 620 and a line part La of a linear polarizing filter and a line part Lb of a linear polarizing filter which orthogonally intersect with each other are alternately arranged per horizontal line of a liquid crystal panel. Taking a cost into consideration, there are possibilities of: using a linear polarizing filter with a same polarizing face for each polarizing filter; and using polarizing filters both of which polarizing angles orthogonally intersect with each other. In these cases, a similar effect can be obtained with a wave plate of ½ length installed on a polarizing filter on the backlight sight source side every other horizontal line of the liquid crystal panel 620.

As shown in FIG. 4, a backlight light source 65 of the embodiment 1 is comprised of four blocks (five white LEDs) which are arranged right and left from the center in two upper and lower rows, including 65 UR and 65 UL on the upper part and 65 DR and 65 DL on the lower part, which are arranged from left to right in both upper row and lower row. They are arranged so that a turn-on of these LED blocks at a high speed can be separately controlled.

A polarizing filter 66 U for the upper part and a polarizing filter 66 D for the lower part are placed in the corresponding positions to each LED block of 65 UR and 65 UL of the upper part and 65 DR and 65 DL of the lower part. These polarizing filters 66U and 66D comprise polarizing filters which polarizing position orthogonally intersects with each other. For example, they form a polarizing face upwards from left to right and a polarizing face downwards from right to left.

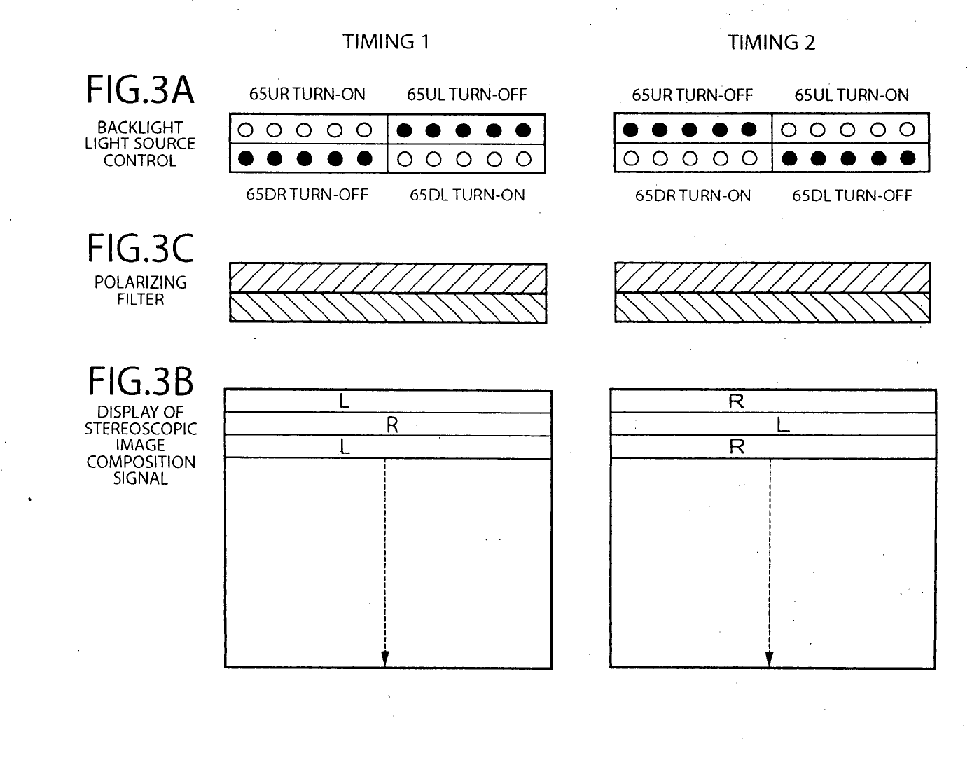

The turn-on control circuit 60 of light source receives a signal from the circuit 30 determining a right image signal and a left image signal. As shown in FIG. 3A, at the timing 1, the circuit 60 illuminates 65 UR of the left upper part and 65 DL of the right lower part of the LED blocks; at the timing 2, the circuit 60 illuminates 65 DR of the left lower part and 65 UL of the right upper part. The circuit performs a switch-over by a signal identifying information which is superimposed and installed together with a stereoscopic image synthesis signal, and then synchronizes a display timing of the stereoscopic image synthesis signal to be displayed on the liquid crystal display element 62.

The liquid crystal display element 62 displays a stereoscopic image synthesis signal 1 at the timing 1 and a stereoscopic image synthesis signal 2 at the timing 2, as shown in FIG. 3B.

At this time, the backlight light source 65 is synchronized with a display conversion timing of the liquid crystal display element 62 to drive a group of 65 UR on the upper right irradiation part and 65 DL on the lower left irradiation part and a group of 65 DR on the lower right irradiation part and 65 UL on the upper left irradiation part to turn on alternately. In the embodiment 1, the observer 80 is located at the center front of a stereoscopic image display and five LEDs each on the right part and the left part from the center line of the both eyes are set for turning on-off.

As shown in FIG. 4, at the timing 1, an image emitted from 65 DL on the lower right irradiation part of the backlight light source 65 is transmitted through the polarizing filter 66D for the left eye and then through a polarizing area for the left display of the polarizing filter 621 to 80 L for the left eye of the observer which is set in a left eye zone; and an image emitted from 65 UR on the upper left irradiation part of the backlight light source 65 is transmitted through the polarizing filter 66U for the right eye and then through a polarizing area for the left display of the polarizing filter 621 to 80 R for the right eye of the observer which is set in a right eye zone.

At the timing 2, an image emitted from 65 UL on the upper right irradiation part of the backlight light source 65 is transmitted through the polarizing filter 66 U for the left eye and then through a polarizing area for the left display of the polarizing filter 621 to 80 L for the left eye of the observer which is set in a left eye zone. Further, an image emitted from 65 DR on the lower left irradiation part of the backlight light source. 65 is transmitted through the polarizing filter 66D for the right eye and then through a polarizing area for the left display of the polarizing filter 621 to 80 R for the right eye of the observer which is set in a right eye zone.

At the time, since the switch-over timing of the backlight light source 65 and the switch-over timing of the stereoscopic image display are synchronized with each other, a stereoscopic image signal at the timing 1 and a stereoscopic image signal at the timing 2 which are shown on the same horizontal line of a liquid crystal display element are alternately displayed, and then the right eye and the left eye of the observer 80 can see an image on entire scanning lines.

Further, since the switch-over circuit 50 of frame image alternately projects a frame image for erasing screen which is generated from the generation device 20 of frame signal for erasing screen by an information from the comparison circuit 40 of image signal and a stereoscopic image synthesis signal on the liquid crystal display element 62, a displayed image is once erased to prevent a cross talk at an information update of the image display from the timing 1 to the timing 2.

A light volume of the backlight light source 65 at this time is controlled by a light volume control circuit 70 of a light source, and then the observer 80 can see a stereoscopic image display with much less flickers.

### INDUSTRIAL APPLICABILITY

As described above, the stereoscopic image display according to the present invention offers the following advantages.

According to the first aspect of this invention, a right stereoscopic image and a left stereoscopic image are displayed on a frame screen at the same time, and then a frame image for erasing screen is displayed. Through repeat of these actions, the previous screen can be completely erased, and an afterimage of the right image, an afterimage of left image, and a cross talk can be eliminated. Further, since the frame for erasing screen gives a shutter effect, an on-focus high-contrast stereoscopic image can be displayed even when a high-speed motion is caught. The effect is also applicable to display a 2D signal.

According to the second aspect of the invention, a means in which the frame image and the frame image for erasing screen are repeated at on or more than twice a conventional speed enables to display a complete motion screen without delay as well as a stereoscopic image with less flicker. If a speed of on or more than twice is performed, a more effect will be given.

According to the third aspect of the invention, a control of details of a frame image for erasing screen according to details of an anterior frame image and a posterior frame image, and details of a right image and a left image enables to perform a smooth continuity of frame images and to provide an effect to reduce flickers and to solve an insufficient light volume. An effect to give a better visualization is also provided.

According to the fourth aspect of the invention, a control of a light volume of the light source at a timing of displaying a frame image for erasing screen according to details of an anterior frame image and a posterior frame image and details of a right image and a left image enables to perform a smooth continuity of frame images, and then an effect to reduce flickers and to solve an insufficient light volume are obtained. If the action is used together with the claim 3, more effect will be produced.

According to the fifth aspect of the invention, an implementation of displaying a frame image for erasing screen during a blanking period of an image signal provides a longer display time of an image, and then provides effects such as reduction of flickers and supplement of insufficient light volume.

1. A stereoscopic image display which simultaneously displays a right stereoscopic image and a left stereoscopic image on a frame screen and which divides an image into an image for the right eye and an image for the left eye of an observer with a polarizing filter and an optical means to display a stereoscopic image, wherein:
an image signal for the right eye and an image signal for the left eye are arranged on an odd horizontal line and an even horizontal line of a frame image, respectively;
the even horizontal line for the image signal for the right eye and the odd horizontal line for the image signal for the left eye are alternately arranged per frame; and,
a frame image in which the image signal for the right eye and the image signal for the left eye are interlaced respectively and a frame image for erasing screen are alternately repeated.

2. A stereoscopic image display as claimed in claim 1, comprising a means, wherein the frame image and the frame image for erasing screen are repeated at on or more than twice a conventional speed. The stereoscopic image display may solve a delay.

3. A stereoscopic image display claimed in claim 1, wherein details of a frame image for erasing screen is controlled according to details of a right image signal, a left image signal, an anterior frame image, and a posterior frame image.

4. A stereoscopic image display claimed in claim 1, wherein a light volume of a light source at a timing of displaying a frame image for erasing screen is controlled according to details of a right image signal, a left image signal, an anterior frame image, and a posterior frame image.

5. A stereoscopic image display claimed in claim 1, wherein a display of a frame image for erasing screen is performed during a blanking period of an image signal.

6. A stereoscopic image display claimed in claim 2, wherein details of a frame image for erasing screen is controlled according to details of a right image signal, a left image signal, an anterior frame image, and a posterior frame image.

7. A stereoscopic image display claimed in claim 2, wherein a light volume of a light source at a timing of displaying a frame image for erasing screen is controlled according to details of a right image signal, a left image signal, an anterior frame image, and a posterior frame image.

8. A stereoscopic image display claimed in claim 2, wherein a display of a frame image for erasing screen is performed during a blanking period of an image signal.
